(19) United States
(12) Patent Application Publication
(10) Pub. No.: US 2006/0201021 A1
(43) Pub. Date: Sep. 14, 2006

(54) Clothes dryer wrinkle release cycle

(75) Inventor: Kirk M. Dunsbergen, Newton, IA (US)

Correspondence Address: MCKEE, VOORHEES & SEASE, P.L.C.;ATTN: MAYTAG/ WHIRLPOOL, 801 GRAND AVENUE, SUITE 3200, DES MOINES, IA, 50309-2721, US

(73) Assignee: Maytag Corporation, Newton, IA (US)

(21) Appl. No.: 11/079,655

(22) Filed: Mar. 14, 2005

(51) Int. Cl. F26B 3/00; F26B 13/10; F26B 21/00

(52) U.S. Cl. 34/499; 34/524

(57) ABSTRACT

A clothes dryer is provided with a wrinkle release cycle premised upon the exhaust temperature of the dryer. When a user selects the wrinkle release cycle, heat is added to the clothes tumbling in the dryer drum until the dryer exhaust temperature reaches a first predetermined value of approximately 150° F. Then, the clothes continue to tumble in the drum without heat until the exhaust temperature decreases to a second predetermined value of approximately 100° F. After the cool down temperature is reach, the machine sounds a signal and continues to tumble the clothes in the drum for another 5-10 minutes before ending the cycle.

### BACKGROUND OF THE INVENTION

Conventional clothes drying machines typically have a cycle to minimize wrinkles in the clothing in the dryer. Such wrinkle release or wrinkle free cycles generally provide heated air for a predetermined time to the clothes tumbling in the dryer, and then continue to tumble the clothes without heat for a predetermined “cool down” time. Such wrinkle release cycles which are predicated upon a first predetermined “heat” time and a second predetermined “cool down” time do not guarantee that the clothes will reach a high enough temperature to release the wrinkles, and will not guarantee that the clothes reach a cool enough temperature to prevent wrinkles from setting in when the cycle stops. Also, if wet or damp clothes are placed in the dryer and the timed wrinkle release cycle is selected, the results will be poor at the end of the timed cycle.

Accordingly, a primary objective of the present invention is a provision of an improved wrinkle release cycle for a clothes dryer.

Another objective of the present invention is a provision of a wrinkle release cycle for a clothes dryer which is premised upon temperatures, rather than time.

A further objective of the present invention is a provision of a wrinkle release cycle which tumbles the clothes in the dryer with heated air being added until a predetermined exhaust temperature is sensed, and then cooling down until a second predetermined temperature is sensed.

Another objective of the present invention is the provision of a wrinkle free cycle in a clothes dryer which heats the clothes to at least 150° F. and then cools the clothes to no greater than 100° F.

A further objective of the present invention is the provision of a clothes dryer with a wrinkle release cycle, including a sensor for sensing exhaust temperature of the dryer and control means for adding heating until a first predetermined temperature is sensed and then tumbling the clothes without heat until a second predetermined temperature is sensed.

Still another objective of the present invention is the provision of a clothes dryer having a wrinkle release cycle which provides greater assurance that wrinkles will be prevented.

These and other objectives will become apparent from the following description of the invention.

### SUMMARY OF THE INVENTION

The clothes dryer of the present invention includes a wrinkle release cycle which is based upon temperatures, rather than time. When a user selects the wrinkle release cycle, the dryer adds heated air to the rotating drum until the exhaust temperature of the dryer reaches a first predetermined value, generally in the range of 150° F. Then, the dryer continues tumbling the clothes without adding heat, until the exhaust temperature cools down to a second predetermined value, preferably no more than 100° F. After the cool down temperature is sensed, a signal is sounded, and the machine continues tumbling the clothes without heat for at least 5 minutes, before shutting down.

### BRIEF DESCRIPTION OF THE DRAWINGS

FIG. 1 is a schematic flow chart illustrating the steps in the wrinkle release cycle of the present invention.

FIG. 2 is a simplified perspective view of a dryer having the wrinkle release cycle of the present invention.

### DETAILED DESCRIPTION OF THE PREFERRED EMBODIMENT

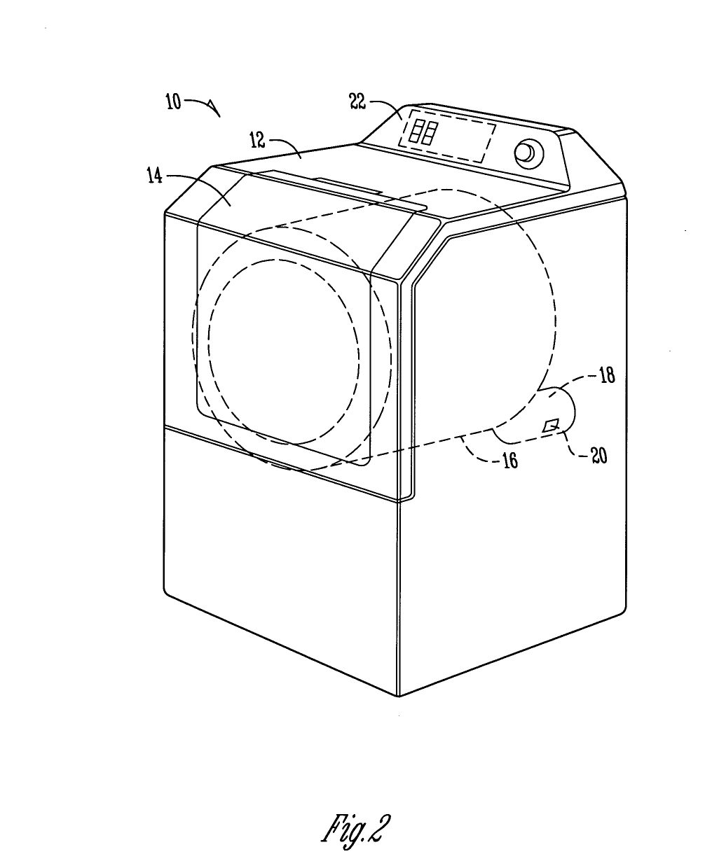

A clothes dryer is generally designated by the reference numeral 10 in FIG. 2. The dryer 10 includes a cabinet 12 with a door 14 to provide access to a rotatable drum 16. The dryer 10 includes a heater (not shown) for supplying hot air to the drum 16 for drying clothes which tumble within the drum 16. An exhaust plenum or vent 18 is provided at the air outlet of the drum 16, and includes a temperature sensor 20 therein. The dryer 10 includes a control panel 22 for controlling the operation of the machine. The control panel 22 includes conventional control such as a microcontroller. The sensor 20 may be a thermistor or a thermostat so as to control the wrinkle release cycle, as described below. A thermostat sensor can employ both a normally open and a normally closed contact, each connected as inputs to the microcontroller. The switching temperatures of the thermostat would be chosen as 150° F. and 100° F.

The present invention is directed towards a wrinkle release cycle for the dryer 10. When a user selects the wrinkle release cycle using the controls on the control panel 22, and then starts the dryer 10, the dryer 10 will turn on the heater to warm the clothes in the drum 16. Simultaneously, the dryer 10 will detect if the clothes are wet via a standard dryness sensor (not shown) in the drum 16. Alternately, the rate of temperature increase, as sensed with the thermistor, may be used as an indicator of the presence of moisture the dryer exhaust temperature increases at a slower rate and will often plateau at an intermediate temperature, perhaps between 110°-120°, for a period of time. If the clothes are detected as being wet, the dryer 10 will automatically go into the wrinkle control drying cycle. If the dryer 10 detects no moisture in the clothes, the dryer 10 will continue to add heat to the tumbling clothes until the exhaust temperature reaches a first predetermined value, as sensed by the sensor 20. Preferably, the first predetermined value is approximately 150° F., or higher, so as to release wrinkles from the clothing. When the first predetermined temperature is sensed by the sensor 20, the dryer 10 will shut off the heater. The dryer 10 will then continue to tumble the clothes in a cool down cycle, until the exhaust temperature reaches a second predetermined value, as sensed by the sensor 20. The second predetermined value preferably is no more than 100° F., which will prevent wrinkles from setting in the clothing. After the second predetermined value is reached, the dryer 10 will sound an audible signal and will then continue to tumble the clothing with no heat for another 5-10 minutes, before stopping rotation of the drum 16 and ending the cycle.

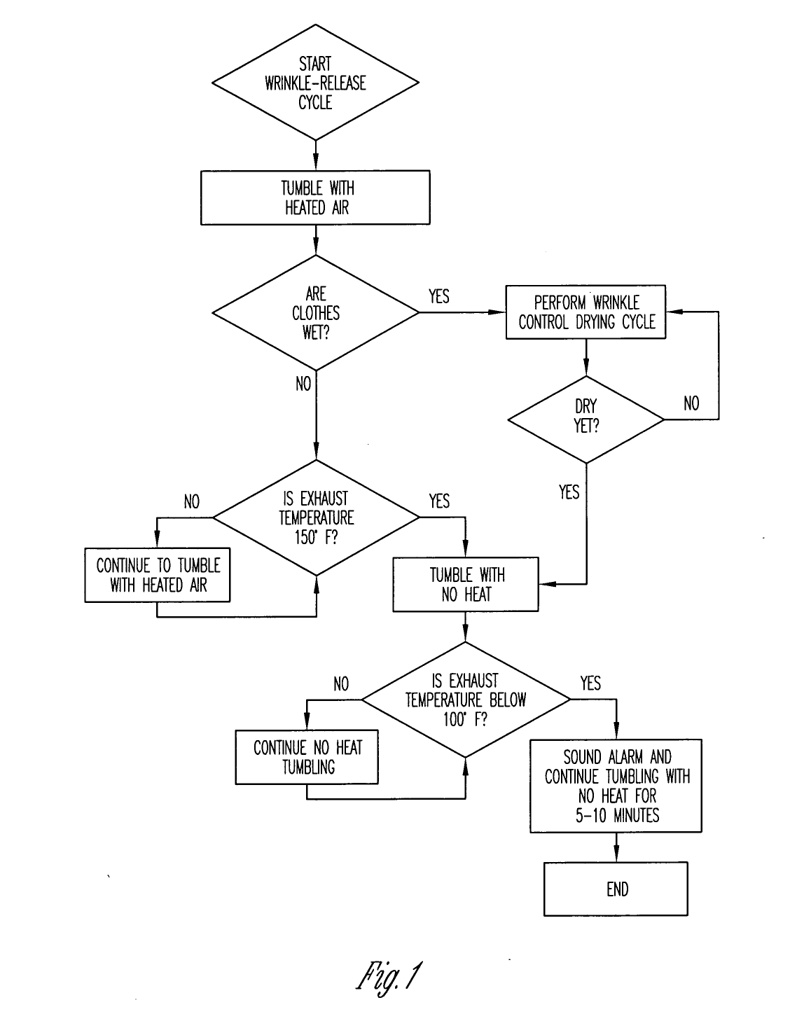

A flow chart of the wrinkle release cycle of the present invention is shown in FIG. 1. As shown in FIG. 1, in the first step, the user starts the wrinkle release cycle, which tumbles the clothes with heated air. A sensor continuously or periodically checks the clothes for moisture. If the clothes are wet, the wrinkle control drying cycle is entered and continues until the clothes are dry. Typically, the exhaust temperature reaches the wrinkle release temperature of 150° during the drying cycle. After the clothes are dry, the controls shut off the heater, but continue rotating the drum 16 for tumbling of the clothes, until the exhaust temperature drops to at least 100° F., so as to preclude new wrinkles developing in the clothing after the cycle ends. After the cool down temperature is sensed, an alarm sounds, and the controls rotate the drum 16 for another 5-10 minutes before the drum rotation is stopped and the cycle ends.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of releasing wrinkles in clothes in a dryer, comprising:
tumbling clothes in the dryer;
adding heat to the dryer until a dryer exhaust temperature increases to a first predetermined value; and
then tumbling the clothes without adding heat until the exhaust temperature decreases to a second predetermined value.

2. The method of claim 1 further comprising sounding a signal after the second predetermined value is reached.

3. The method of claim 2 further comprising continuing tumbling for at least 5 minutes after the signal is sounded.

4. The method of claim 1 wherein the first predetermined value is at least 150° F.

5. The method of claim 1 wherein the first predetermined value is approximately 150° F.

6. The method of claim 1 wherein the second predetermined value is at most 100° F.

7. The method of claim 1 wherein the second predetermined value is approximately 100° F.

8. A clothes dryer with a wrinkle release cycle, comprising:
a sensor for sensing first and second predetermined exhaust temperatures of the dryer; and
control means for adding heat to the dryer until the sensor senses the first predetermined temperature, then withholding heat to the dryer until the sensor senses a second predetermined temperature;
a signal generator which is actuated after the second predetermined temperature is sensed.

9. The clothes dryer of claim 8 wherein the first predetermined value is at least 150° F.

10. The clothes dryer of claim 8 wherein the first predetermined value is approximately 150° F.

11. The clothes dryer of claim 8 wherein the second predetermined value is at most 100° F.

12. The clothes dryer of claim 8 wherein the second predetermined value is approximately 100° F.

13. The clothes dryer of claim 8 wherein the control means continues to tumble the dryer for at least 5 minutes after the signal is actuated.

14. The clothes dryer of claim 8 wherein the signal is audible.

15. The clothes dryer of claim 8 wherein the control means includes a thermistor.

16. A method of processing clothes in a dryer, comprising:
receiving a user selection of a wrinkle release cycle;
tumbling the clothes while adding heat to the dryer;
sensing whether the clothes are wet;
switching from a wrinkle release cycle to an automatic drying cycle when wet clothes are detected in the sensing step; and
tumbling the clothes without adding heat until the dryer exhaust temperature decreases to a predetermined temperature.

17. The method of claim 16 further comprising sounding a signal after the predetermined value is reached.

18. The method of claim 17 further comprising continuing tumbling for at least 5 minutes after the signal is sounded.

19. The method of claim 16 wherein the predetermined value is at most 100° F.
